(19) United States
(12) Patent Application Publication
(10) Pub. No.: US 2026/0268110 A1
(43) Pub. Date: Sep. 10, 2026

(54) THREE-DIMENSIONAL PATTERN CARD AND METHOD FOR MANUFACTURING THE SAME

(71) Applicant: BIOSMART CORPORATION, Seoul (KR)

(72) Inventor: Tae Ki YOON, Cheonan-si (KR)

(21) Appl. No.: 19/661,638

(22) Filed: Apr. 28, 2026

Related U.S. Application Data
(62) Division of application No. 19/312,121, filed on Aug. 27, 2025.
Application No. 19/312,121 is a continuation-in-part of application No. PCT/KR2023/012812, filed on Aug. 29, 2023.

(30) Foreign Application Priority Data
Apr. 6, 2023 (KR) 10-2023-0045686

(51) Int. Cl. G06K 19/077

(52) U.S. Cl. CPC G06K 19/07722; G06K 19/07773

(57) ABSTRACT

Provided is a three-dimensional pattern card and a method of manufacturing the same. The method includes: (a) preparing a master mold in which a pattern of a three-dimensional shape is engraved on one surface; (b) fabricating a three-dimensional pattern module by forming a three-dimensional pattern on a surface of a transparent sheet made of a synthetic resin material using the master mold; (c) fabricating a rear card body module by sequentially laminating and bonding a first core sheet, an antenna inlay sheet, a second core sheet, and a rear protective sheet; (d) applying a UV adhesive to a surface of the first core sheet of the rear card body module; and (e) laminating the three-dimensional pattern module on the UV adhesive applied surface of the rear card body module and irradiating UV to cure the adhesive so as to bond the rear card body module and the three-dimensional pattern module.

### TECHNICAL FIELD

The present invention relates to a three-dimensional pattern card and a method for manufacturing the same. More particularly, the present invention relates to a three-dimensional pattern card and a manufacturing method thereof, in which a pattern or design is formed in a more three-dimensional manner on a three-dimensional pattern module, and a rear card body module and the three-dimensional pattern module are fabricated and subsequently combined. As a result, the three-dimensional pattern card according to the present invention is configured not only to prevent bending of the card but also to further enhance the three-dimensional effect of the pattern or design.

### BACKGROUND ART

Credit cards are used for purposes such as identification, payment, and the extension of credit, and their shapes and designs have become increasingly elaborate in order to provide artistic value and accessory functions. In addition, the shape and design of a credit card, together with functions such as services, discounts, and reward points, serve as important factors influencing the selection of a credit card. Accordingly, card manufacturers have endeavored to meet diverse customer demands by devising cards that differ significantly not only in appearance and design but also in functional aspects. As one of such efforts, various attempts have been proposed to enhance the design of credit cards by adding a three-dimensional pattern to the card, thereby providing a three-dimensional effect and creating a more elaborate appearance.

Korean Patent Publication No. 10-2012-0120520, filed and published by the present applicant, discloses “method for manufacturing a card with a special pattern”. The above patent proposes a technique in which a special patterned sheet having a three-dimensional pattern corresponding to a special design is produced using a pattern mold with a three-dimensional pattern, and the special patterned sheet and other constituent sheets are laminated and bonded together by hot pressing. This technique is characterized in that a fine pattern can be formed on a card by means of the special patterned sheet.

However, in the above-described technique, since the sheets including the special patterned sheet are laminated and bonded by hot pressing, there arises a problem in that the synthetic resin sheets shrink due to the high temperature. In addition, during the card manufacturing process, when a high temperature pressing process is carried out with an antenna embedded or a magnetic stripe attached on the rear side, there also arises a problem in that marks of such components, such as the antenna or the magnetic stripe, appear on the surface of the card.

Accordingly, the present invention aims to propose a solution capable of further enhancing the three-dimensional effect of a three-dimensional pattern while preventing the card from shrinking or warping.

### SUMMARY OF THE INVENTION

In order to overcome the aforementioned problems, it is an object of the present invention to provide a three-dimensional pattern card and a method for manufacturing the same, in which a rear card body module and a three-dimensional pattern module are fabricated, the three-dimensional pattern module is produced without a high-temperature pressing process, and the modules are bonded together using a UV adhesive. As a result, the card is configured not only to prevent shrinkage but also to further enhance the three-dimensional effect of the pattern or design.

In order to achieve the foregoing technical object, a three-dimensional pattern card according to a first aspect of the present invention comprises: a three-dimensional pattern module having a three-dimensional pattern formed on one surface; a rear card body module made of a synthetic resin material; and a UV adhesive layer disposed between the three-dimensional pattern module and the rear card body module, the UV adhesive layer being formed by curing an adhesive of a UV-curable material to bond the three-dimensional pattern module and the rear card body module together. The rear card body module preferably comprises: an antenna inlay sheet whose main body is made of a synthetic resin material and on a first surface of which an antenna coil is mounted; a first core sheet made of a synthetic resin material and disposed on the first surface of the antenna inlay sheet; a second core sheet made of a synthetic resin material and disposed on a second surface of the antenna inlay sheet where the antenna coil is not mounted; and a rear protective sheet made of a PVC material and mounted on the surface of the second core sheet. The three-dimensional pattern module preferably comprises: a transparent sheet made of a transparent synthetic resin material; and a three-dimensional pattern layer formed of a three-dimensional pattern molded by curing a UV-curable material on a surface of the transparent sheet.

In the three-dimensional pattern card according to the first aspect described above, the three-dimensional pattern module further preferably comprises a multilayer deposition film formed by sequentially depositing predetermined materials on a surface of the three-dimensional pattern in order to enhance the three-dimensional effect of the pattern of the three-dimensional pattern layer. The types, deposition order, and deposition thickness of the materials constituting the multilayer deposition film are preferably determined according to the color, transparency, and reflectivity required by the pattern of the three-dimensional pattern layer.

In the three-dimensional pattern card according to the first aspect described above, the three-dimensional pattern module further preferably comprises a printing layer disposed between the three-dimensional pattern layer and the transparent sheet, the printing layer being preferably formed by digital-printing a predetermined design on a surface of the transparent sheet.

In the three-dimensional pattern card according to the first aspect described above, the rear card body module further preferably comprises a light-shielding layer disposed on an upper surface of the first core sheet in order to block light from being transmitted through the rear card body module. The light-shielding layer is preferably formed by applying a light-blocking material onto the upper surface of the first core sheet.

In a method for manufacturing a three-dimensional pattern card according to a second aspect of the present invention, the method comprises the steps of: (a) fabricating a master mold in which a three-dimensional patterned design is engraved on one surface; (b) fabricating a three-dimensional pattern module by forming a three-dimensional pattern on a surface of a transparent sheet made of a synthetic resin material using the master mold; (c) fabricating a rear card body module by sequentially laminating and bonding a first core sheet made of a synthetic resin material, an antenna inlay sheet having an antenna coil mounted on its surface, a second core sheet made of a synthetic resin material, and a rear protective sheet; (d) applying a UV adhesive on a surface of the first core sheet of the rear card body module; and (e) laminating the three-dimensional pattern module on an upper portion of the UV adhesive applied to the surface of the rear card body module, and irradiating UV light to bond the rear card body module and the three-dimensional pattern module together.

In the method for manufacturing a three-dimensional pattern card according to the second aspect described above, the step (b) preferably comprises the steps of: (b1) applying a UV liquid material onto one surface of a transparent sheet made of a synthetic resin material; (b2) coupling a master mold onto the UV liquid material applied to the surface of the transparent sheet, such that the surface of the master mold having the engraved patterned design is brought into contact with the UV liquid material; (b3) irradiating UV light onto the resultant product in which the transparent sheet and the master mold are coupled, thereby UV-curing the UV liquid material; and (b4) separating the master mold to form a three-dimensional pattern layer formed by curing the UV liquid material on one surface of the transparent sheet.

In the method for manufacturing a three-dimensional pattern card according to the second aspect described above, the step (b) further preferably comprises the step of: (b5) forming a multilayer deposition film by sequentially depositing predetermined materials on a surface of the three-dimensional pattern of the three-dimensional pattern layer in order to enhance the three-dimensional effect of the pattern of the three-dimensional pattern layer, wherein the types, deposition order, and deposition thickness of the materials constituting the multilayer deposition film are determined according to color, transparency, and reflectivity required by the pattern of the three-dimensional pattern layer.

In the method for manufacturing a three-dimensional pattern card according to the second aspect described above, the step (b1) is preferably performed by digital printing a predetermined design on a surface of the transparent sheet to form a printing layer, and applying a UV liquid material onto a surface of the printing layer.

In the method for manufacturing a three-dimensional pattern card according to the second aspect described above, the step (c) preferably comprises the steps of: (c1) sequentially laminating a first core sheet made of a synthetic resin material, an antenna inlay sheet having an antenna coil mounted on its surface, a second core sheet made of a synthetic resin material, and a rear protective sheet; (c2) heating and pressing the laminated product to bond the sheets together; and (c3) applying a light-blocking material onto an upper surface of the first core sheet to form a light-shielding layer, thereby fabricating the rear card body module.

A three-dimensional pattern card according to a third aspect of the present invention comprises: a three-dimensional pattern module having a three-dimensional pattern formed on one surface; and a rear card body module made of a synthetic resin material. The rear card body module comprises: an antenna inlay sheet whose main body is made of a synthetic resin material and on one surface of which an antenna coil is mounted; a first core sheet made of a synthetic resin material and disposed on an upper surface of the antenna inlay sheet on which the antenna coil is mounted; a second core sheet made of a synthetic resin material and disposed on a lower surface of the antenna inlay sheet; and a rear protective sheet made of a synthetic resin material and disposed on a surface of the second core sheet. The three-dimensional pattern module comprises: a transparent sheet made of a transparent synthetic resin material; and a three-dimensional pattern layer formed by curing a UV-curable material into a three-dimensional pattern on a surface of the transparent sheet.

In the three-dimensional pattern card according to the third aspect described above, the three-dimensional pattern module further preferably comprises a multilayer deposition film formed by sequentially depositing predetermined materials on a surface of the three-dimensional pattern of the three-dimensional pattern layer in order to enhance the three-dimensional effect of the pattern of the three-dimensional pattern layer. The types, deposition order, and deposition thickness of the materials constituting the multilayer deposition film are preferably determined according to the color, transparency, and reflectivity required by the pattern of the three-dimensional pattern layer.

In the three-dimensional pattern card according to the third aspect described above, the three-dimensional pattern module further preferably comprises a printing layer disposed between the three-dimensional pattern layer and the transparent sheet, the printing layer being formed by printing a predetermined design on a surface of the transparent sheet.

The three-dimensional pattern card according to the third aspect further preferably comprises a light-shielding layer disposed between the three-dimensional pattern module and the rear card body module in order to block light from being transmitted through the rear card body module. The light-shielding layer is preferably formed by applying a light-blocking material onto one surface of the three-dimensional pattern module.

The three-dimensional pattern card according to the third aspect further preferably comprises an upper printing sheet disposed on an upper surface of the three-dimensional pattern module. The upper printing sheet preferably comprises: a first transparent sheet made of a transparent synthetic resin material; a design printing layer formed by printing a predetermined design on a surface of the first transparent sheet; and a second transparent sheet made of a transparent synthetic resin material and formed on a surface of the design printing layer.

The three-dimensional pattern card according to the present invention having the above-described configuration can be fabricated by separately producing the three-dimensional pattern module, in which a three-dimensional pattern is formed, and the rear card body module, and then bonding them together. As a result, the three-dimensional pattern card according to the present invention can be manufactured without subjecting the three-dimensional pattern module to a high-temperature pressing process. Accordingly, by fabricating the three-dimensional pattern module without a high-temperature pressing process, the three-dimensional pattern card according to the present invention does not undergo shrinkage or warping.

In general, during the card manufacturing process, when a high-temperature pressing process is performed with an antenna embedded or a magnetic stripe attached on the rear side of the card, marks of such components, such as the antenna or the magnetic stripe, can be appeared on the card surface. However, the three-dimensional pattern card according to the present invention can prevent marks of the components from appearing on the card surface by bonding through UV irradiation without a high-temperature pressing process.

### BRIEF DESCRIPTION OF THE DRAWINGS

FIG. 1 is an exploded cross-sectional view illustrating a three-dimensional pattern card according to a first embodiment of the present invention.

FIG. 2 is a flowchart sequentially illustrating a method for manufacturing the three-dimensional pattern card according to the first embodiment of the present invention.

FIG. 3 is a flowchart illustrating a step of fabricating a master mold in the method for manufacturing the three-dimensional pattern card according to the first embodiment of the present invention.

FIGS. 4A and 4B are a perspective view and a side view of the master mold in the method for manufacturing the three-dimensional pattern card according to the first embodiment of the present invention.

FIG. 5 comprises cross-sectional views illustrating steps of fabricating a three-dimensional pattern module in the method for manufacturing the three-dimensional pattern card according to the first embodiment of the present invention.

FIG. 6 comprises cross-sectional views illustrating steps of fabricating a rear card body module in the method for manufacturing the three-dimensional pattern card according to the first embodiment of the present invention.

FIG. 7 comprises cross-sectional views illustrating steps of completing a card sheet by combining the three-dimensional pattern module and the rear card body module in the method for manufacturing the three-dimensional pattern card according to the first embodiment of the present invention.

FIG. 8 is a schematic view illustrating a process of fabricating unit cards by cutting the card sheet in the method for manufacturing the three-dimensional pattern card according to the first embodiment of the present invention.

FIG. 9 comprises schematic views illustrating processes of fabricating and completing unit cards in the method for manufacturing the three-dimensional pattern card according to the first embodiment of the present invention.

FIG. 10 is an exploded cross-sectional view illustrating a three-dimensional pattern card according to a second embodiment of the present invention.

### DETAILED DESCRIPTION OF THE INVENTION

Hereinafter, preferred embodiments of the present invention will be described in detail with reference to the accompanying drawings, with respect to a three-dimensional pattern card and a method for manufacturing the same.

### First Embodiment

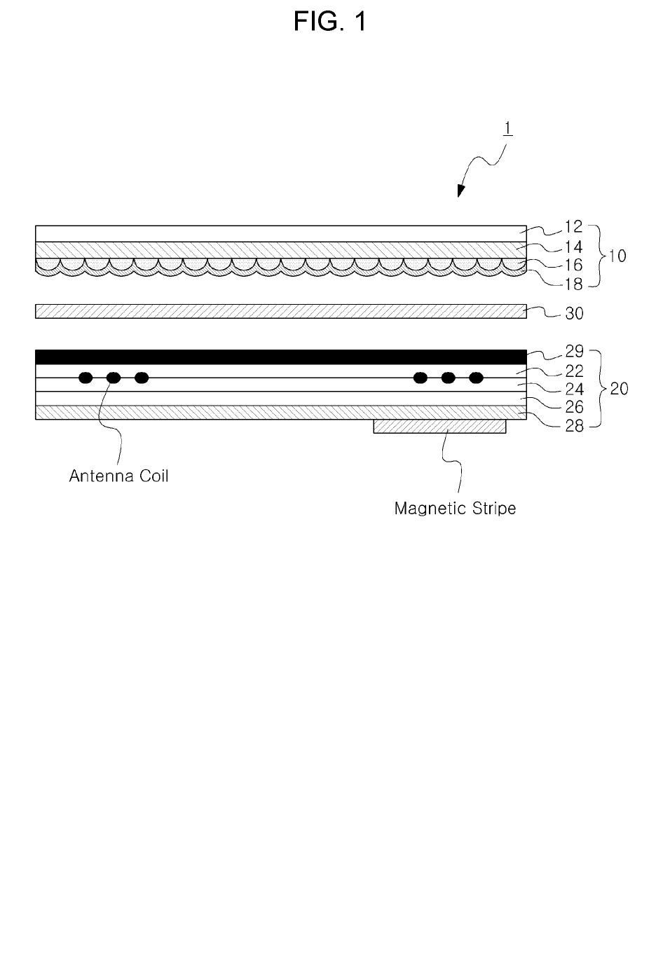

FIG. 1 is an exploded cross-sectional view illustrating a three-dimensional pattern card according to a first embodiment of the present invention. Referring to FIG. 1, a three-dimensional pattern card 1 according to the present invention comprises a three-dimensional pattern module 10, a rear card body module 20, and a UV adhesive layer 30. The three-dimensional pattern module 10 is a module having a three-dimensional pattern formed on one surface. The rear card body module 20 may be made of a synthetic resin material. The UV adhesive layer 30 is an adhesive layer formed by curing an adhesive of a UV-curable material through UV irradiation. The UV adhesive layer 30 is disposed between the three-dimensional pattern module 10 and the rear card body module 20 so as to bond the three-dimensional pattern module and the rear card body module together.

The rear card body module 20 is completed by sequentially laminating a first core sheet 22, an antenna inlay sheet 24, a second core sheet 26, and a rear protective sheet 28, and then bonding them together under high temperature and high pressure. The antenna inlay sheet 24 has a main body made of a synthetic resin material, and an antenna coil is mounted on one surface of the main body. The first core sheet 22 and the second core sheet 26 are made of a synthetic resin material and may be disposed on an upper surface and a lower surface of the antenna inlay sheet, respectively. The rear protective sheet 28 is made of a transparent synthetic resin material and may be disposed on a surface of the second core sheet 26. Meanwhile, the synthetic resin material in the present specification may be selected from one of Polyvinyl Chloride (PVC), Polyethylene Terephthalate (PET), Polyethylene Terephthalate Glycol (PET-G), and Polycarbonate (PC).

The rear card body module 20 may further comprise a light-shielding layer 29 disposed on an upper surface of the first core sheet 22. The light-shielding layer 29 can block light incident on the front surface of the card from being transmitted through the rear card body module 20. The light-shielding layer 29 may be formed by applying a light-blocking material onto the upper surface of the first core sheet 22.

The three-dimensional pattern module 10 may be formed by sequentially laminating a transparent sheet 12 made of a synthetic resin material, a printing layer 14, a three-dimensional pattern layer 16, and a multilayer deposition film 18. The transparent sheet 12 is made of a transparent synthetic resin material. The printing layer 14 may be formed by digitally printing a design including arbitrary patterns, characters, or the like on a surface of the transparent sheet 12. The three-dimensional pattern layer 16 is formed of a three-dimensional pattern molded by curing a UV-curable material on a surface of the printing layer 14. The multilayer deposition film 18 may be formed by sequentially depositing predetermined different materials on a surface of the three-dimensional pattern of the three-dimensional pattern layer 16 in order to enhance the three-dimensional effect of the pattern of the three-dimensional pattern layer. The multilayer deposition film 18 is a layer for enhancing the three-dimensional effect of the pattern formed in the three-dimensional pattern layer 16. The types, deposition order, and deposition thickness of the materials constituting the multilayer deposition film 18 may be determined according to the color, transparency, and reflectivity required by the pattern of the three-dimensional pattern layer 16.

As deposition materials of the multilayer deposition film, oxides and inorganic metals may be used, and the color of the pattern may be determined depending on the deposition materials. For example, a multilayer deposition film that makes the pattern appear transparent may be configured by sequentially laminating TiO₂, SiO₂, and TiO₂. In this case, the degree of transparency and reflectivity may be determined depending on the thickness of SiO₂. A multilayer deposition film that makes the pattern appear silver in color may be configured by sequentially laminating SiO₂, Al₂O₃, indium, and Al₂O₃, and in this case, the silver color may be formed depending on the thickness of indium. In addition, a multilayer deposition film that makes the pattern appear gold in color may be configured by sequentially laminating TiO₂, Al₂O₃, indium, and Al₂O₃, and in this case, the gold color may be formed depending on the thickness of TiO₂. As such, the material structure of the layers constituting the multilayer deposition film and the thicknesses of the respective layers can be designed according to the desired color and reflectivity to be implemented in the pattern. It should be understood that the above examples of material combinations and thicknesses are merely illustrative and are not intended to limit the scope of the present invention.

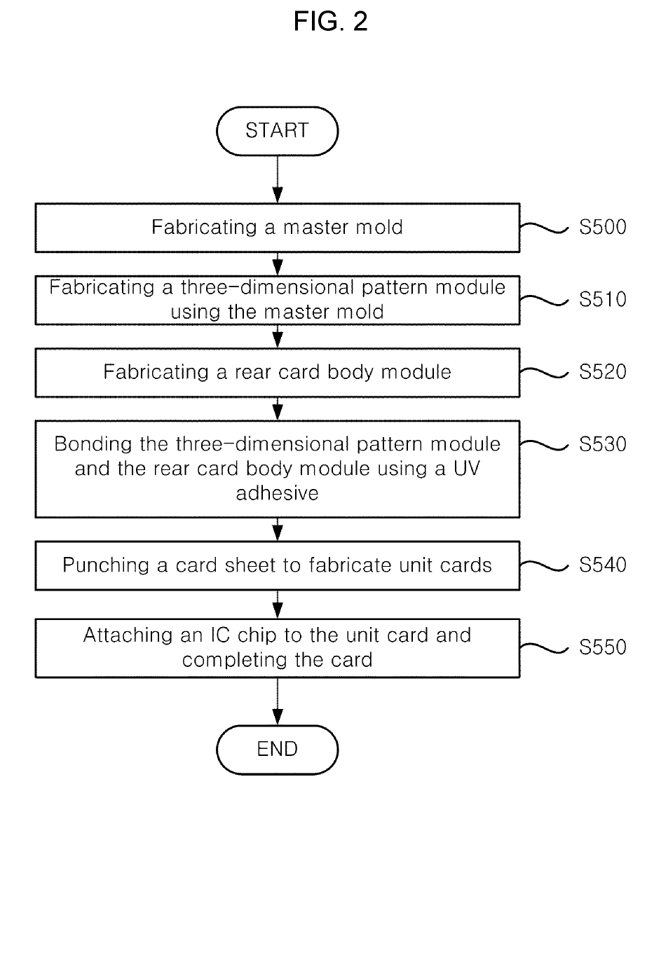

Hereinafter, a method for manufacturing a three-dimensional pattern card according to the first embodiment of the present invention having the above-described configuration will be described in detail. FIG. 2 is a flowchart sequentially illustrating a method for manufacturing a three-dimensional pattern card according to the first embodiment of the present invention. Referring to FIG. 2, the method for manufacturing the three-dimensional pattern card comprises the steps of fabricating a master mold (step 500), fabricating a three-dimensional pattern module (step 500), fabricating a rear card body module (step 500), completing a card sheet (step 500), fabricating unit cards (step 500), and attaching an integrated circuit (IC) chip to the unit cards (step 500), thereby completing the three-dimensional pattern card. Hereinafter, each step will be described in detail.

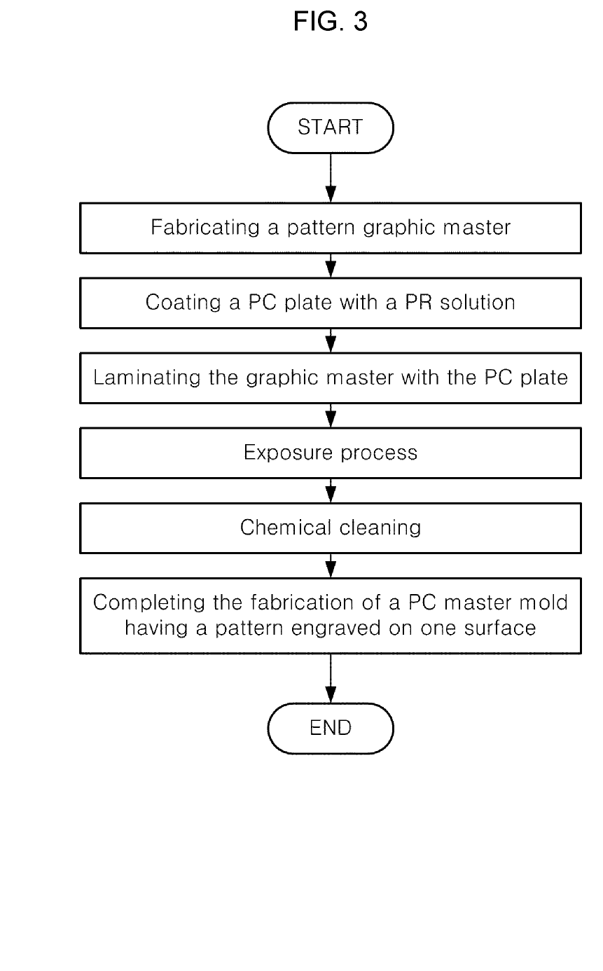

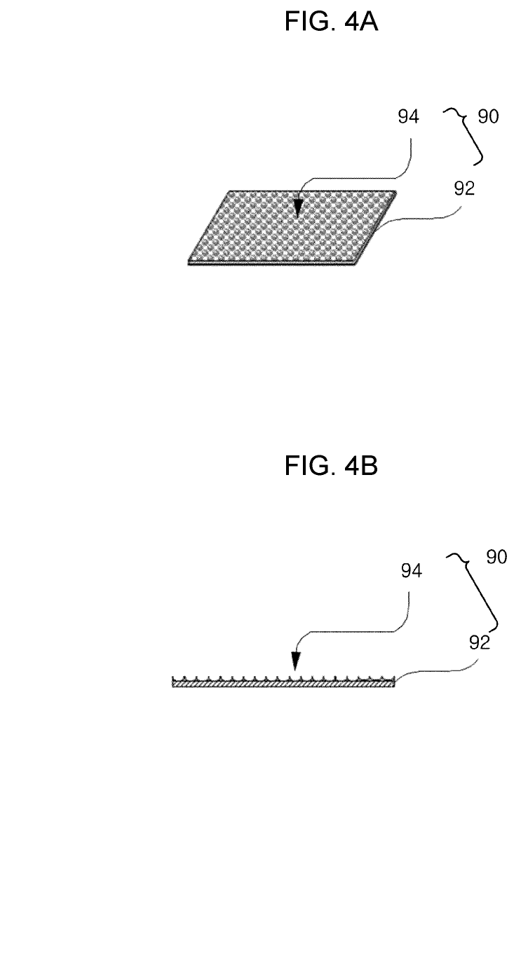

Hereinafter, with reference to FIGS. 3 and 4, the step 500 of fabricating a master mold having an engraved patterned design will be described in detail. FIG. 3 is a flowchart illustrating the master-mold fabrication step in the method for manufacturing the three-dimensional pattern card according to the first embodiment of the present invention. Referring to FIG. 3, step 500 comprises: first, producing a graphic master of the patterned design; next, applying a photoresist (PR) solution to a plate of polycarbonate (PC) material and bringing the graphic master into contact with the PR-coated PC plate; and then exposing the combined article to light and developing it (chemical washing), thereby completing a PC master mold having the pattern engraved on its surface. FIGS. 4A and 4B are a perspective view and a side view illustrating a master mold in the method for manufacturing the three-dimensional pattern card according to the first embodiment of the present invention. Referring to FIGS. 4A and 4B, a master mold 90 according to the present invention is completed with a three-dimensional pattern 94 engraved on one surface of a PC plate 92.

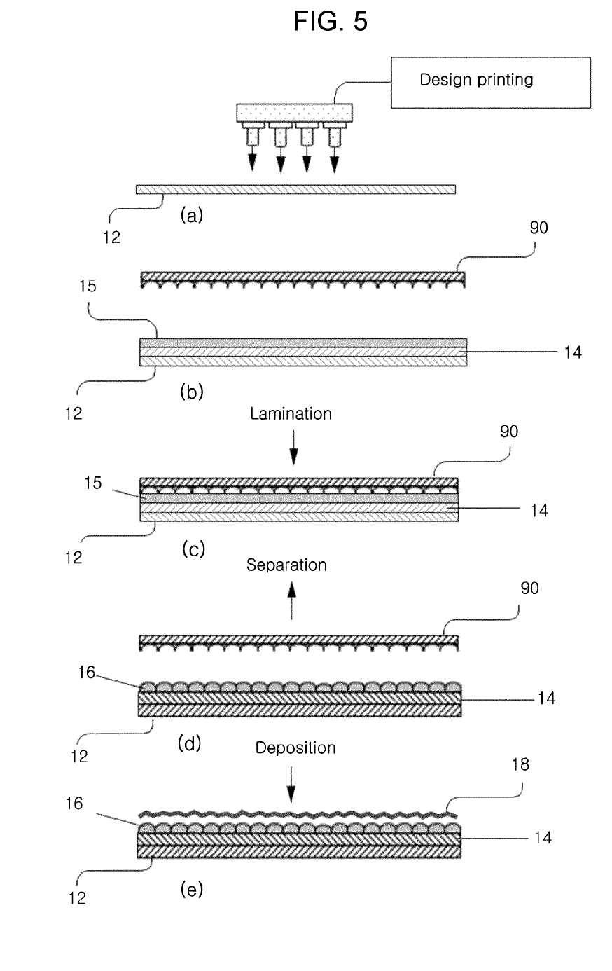

Hereinafter, the step 510 of fabricating the three-dimensional pattern module using the master mold will be described in detail. FIG. 5 comprises cross-sectional views illustrating steps of fabricating the three-dimensional pattern module in the method for manufacturing the three-dimensional pattern card according to the first embodiment of the present invention. Referring to (a) in FIG. 5, in order to manufacture the three-dimensional pattern module 10, a predetermined design is digitally printed on one surface of a transparent sheet 12 made of a synthetic resin material to form a printing layer 14. Next, referring to (b) in FIG. 5, a UV liquid material 15 is applied onto the surface of the printing layer 14. Next, referring to (c) in FIG. 5, a master mold 90 is combined on the UV liquid material 15 applied to the surface of the transparent sheet 12, such that the surface of the master mold having the engraved pattern contacts the UV liquid material 15. Subsequently, the resulting structure, in which the transparent sheet 12 and the master mold 90 are combined, is irradiated with UV light to cure the UV liquid material 15. Next, referring to (d) in FIG. 5, the master mold 90 is separated from the cured structure to form a three-dimensional pattern layer 16 on one surface of the transparent sheet 12, the three-dimensional pattern layer 16 being made of the cured UV liquid material and having a three-dimensional patterned shape. Next, referring to (e) in FIG. 5, in order to enhance the stereoscopic effect of the pattern of the three-dimensional pattern layer 16, predetermined materials are sequentially deposited on the surface of the three-dimensional patterned shape of the three-dimensional pattern layer 16 to form a multilayer deposition film 18. At this time, the types, deposition order, and deposition thickness of the materials constituting the multilayer deposition film 18 may be determined according to the color, transparency, and reflectivity required by the pattern of the three-dimensional pattern layer 16.

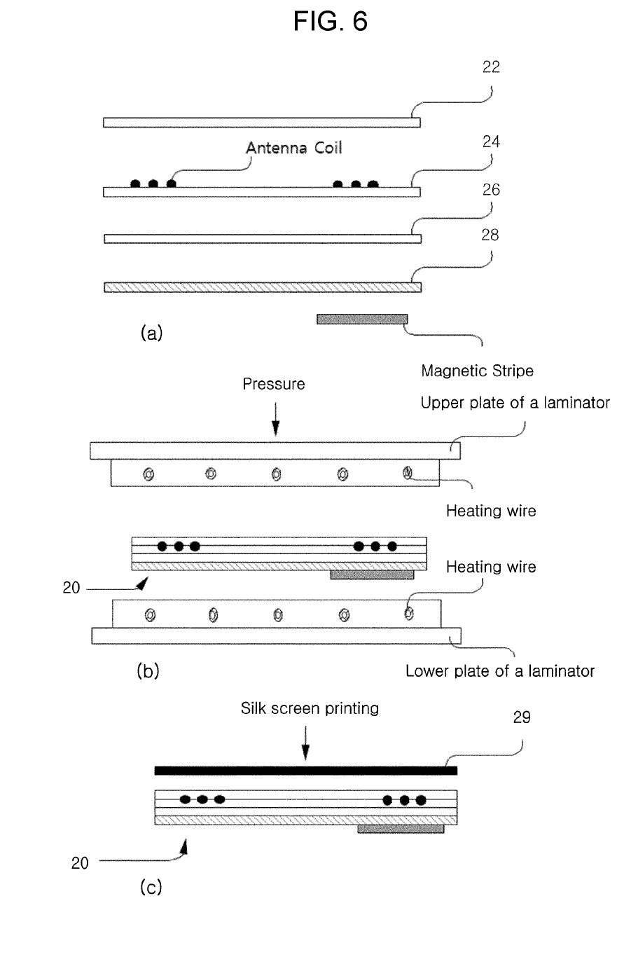

Hereinafter, the step 520 of manufacturing the rear card body module 20 will be specifically described. FIG. 6 illustrates cross-sectional views showing steps of manufacturing the rear card body module 20 in the method of manufacturing a three-dimensional pattern card according to a first embodiment of the present invention. Referring to (a) in FIG. 6, in order to manufacture the rear card body module 20, a first core sheet 22, an antenna inlay sheet 24, a second core sheet 26, a rear protective sheet 28, and a magnetic stripe are sequentially laminated. Here, the first core sheet 22 and the second core sheet 26 may be made of a synthetic resin material, and the antenna inlay sheet 24 may be configured such that an antenna coil is mounted on its surface. Next, referring to (b) in FIG. 6, the laminated product is bonded by heating and pressing using a laminator equipped with a heating wire. Next, referring to (c) in FIG. 6, a light-blocking material is applied onto an upper surface of the first core sheet by a silk screen printing method to form a light-shielding layer 29, thereby completing the rear card body module 20.

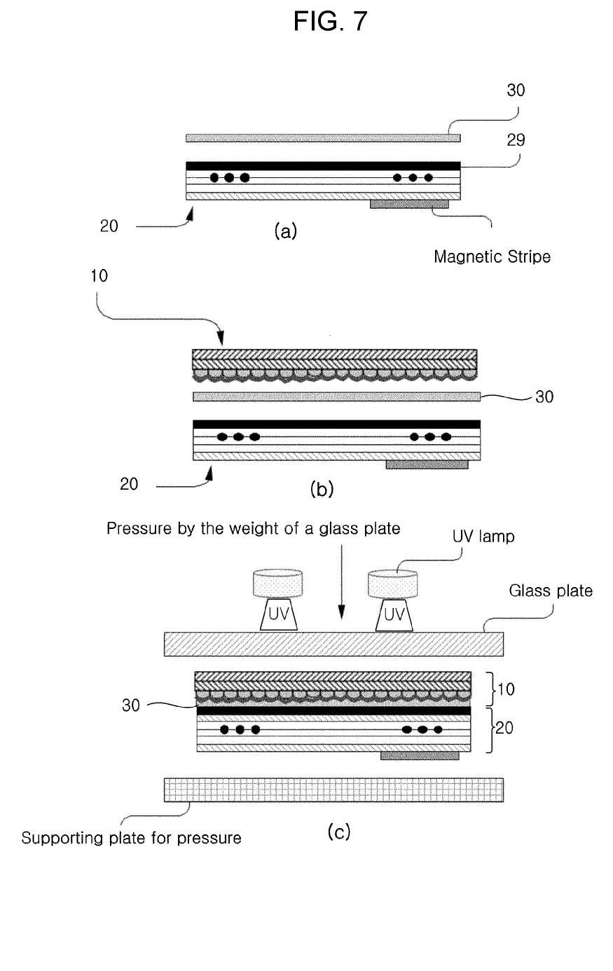

Hereinafter, the step 530 of completing a card sheet by combining the three-dimensional pattern module and the rear card body module will be described in detail. FIG. 7 comprises cross-sectional views illustrating steps of completing a card sheet by combining the three-dimensional pattern module and the rear card body module in the method for manufacturing the three-dimensional pattern card according to the first embodiment of the present invention. Referring to (a) in FIG. 7, in order to combine the three-dimensional pattern module 10 and the rear card body module 20, a UV adhesive 30 is first applied onto an upper surface of the light-shielding layer 29 of the rear card body module 20. Referring to (b) in FIG. 7, the three-dimensional pattern module 10 is laminated on the UV adhesive 30 applied to the surface of the rear card body module 20. Referring to (c) in FIG. 7, while applying pressure by a glass plate weight, UV irradiation is performed to cure the UV adhesive 30, thereby bonding the rear card body module 20 and the three-dimensional pattern module 10 together. Through the above-described process, the card sheet is completed.

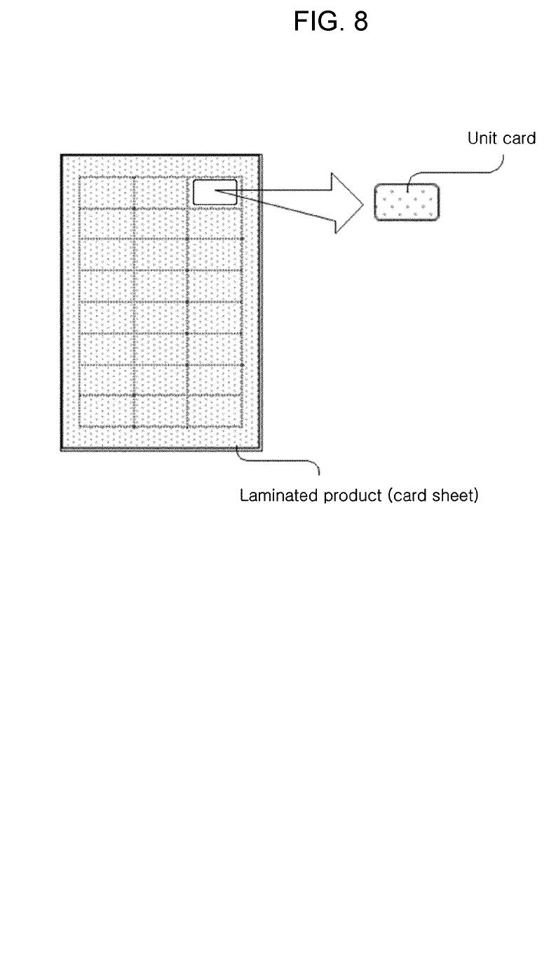

Next, as shown in FIG. 8, the completed card sheet is cut into a predetermined card size to fabricate unit cards (step 540). FIG. 8 is a schematic view illustrating a process of fabricating unit cards by cutting the card sheet, which is the bonded product, in the method for manufacturing the three-dimensional pattern card according to the present invention.

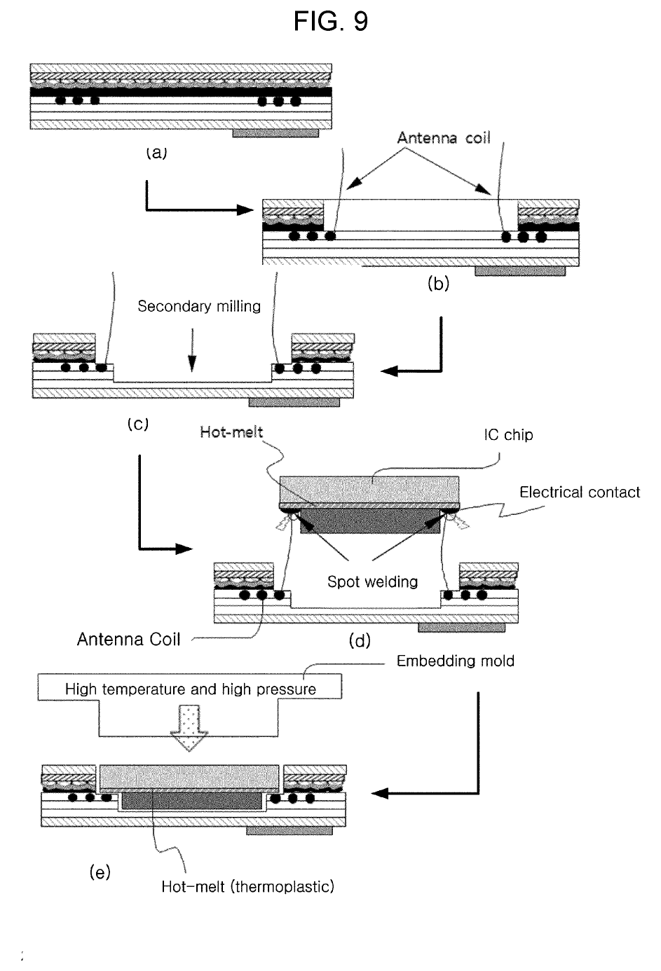

Hereinafter, the step 550 of attaching an IC chip to the unit card to complete the card will be described in detail. FIG. 9 comprises schematic views illustrating processes of fabricating and completing unit cards in the method for manufacturing the three-dimensional pattern card according to the present invention. (a) in FIG. 9 is a cross-sectional view of a unit card, and (b) in FIG. 9 is a cross-sectional view illustrating a state in which terminals of the antenna wiring are brought out. Referring to (b) in FIG. 9, in the card of (a) in FIG. 9, in order to connect terminals of a card IC chip module with terminals of antenna wiring of the antenna inlay sheet, a milling process is performed on the card body to form an insertion hole for inserting the IC chip module. The terminals of the antenna wiring of the antenna inlay sheet embedded in the card body are then drawn out and protruded above the insertion hole. Next, referring to (c) in FIG. 9, a secondary milling process is performed on a central region of the insertion hole of the card body to complete the insertion hole, in accordance with the size of a rear mold of the card IC chip module. Next, referring to (d) in FIG. 9, two contact points between the terminals of the card IC chip module and the terminals of the antenna wiring are welded by a spot-welding method, thereby electrically connecting the card IC chip module and the antenna wiring. Next, referring to (e) in FIG. 9, by applying heat and pressure to the front surface of the card body using an embedding mold, the card IC chip module is embedded into the insertion hole of the card body. Thereafter, according to a predetermined card design, a hologram and a signature panel are stamped on a surface of the rear protective sheet located on the rear surface of the card body, thereby completing the three-dimensional pattern card according to the present invention.

By virtue of the foregoing configuration, the three-dimensional pattern card according to the present invention is configured so that the three-dimensional effect of the embossed pattern can be enhanced without any overall warping phenomenon.

### Second Embodiment

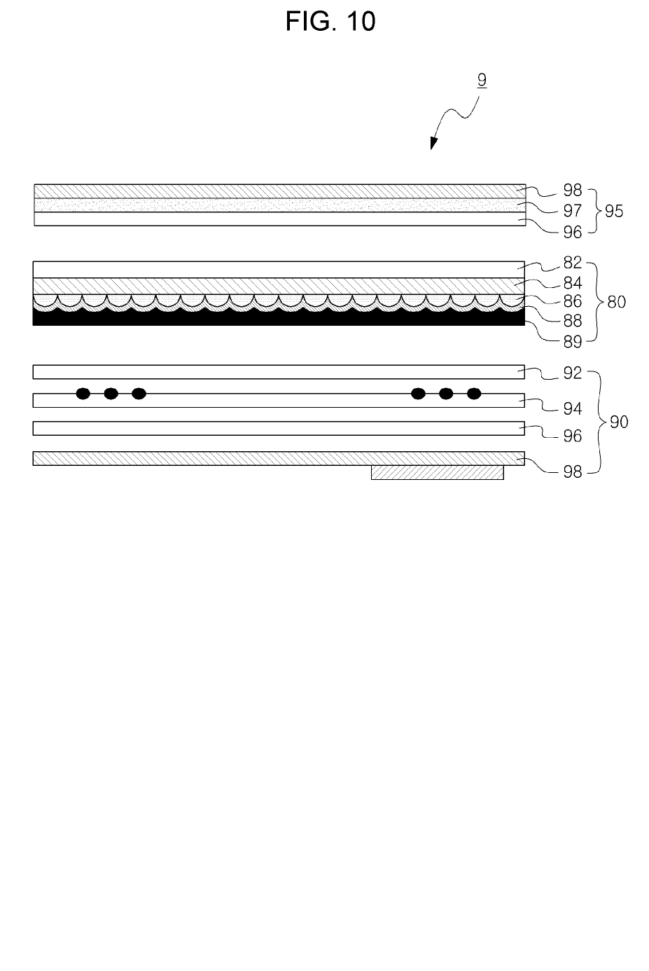

Hereinafter, with reference to the accompanying drawings, the structure of a three-dimensional pattern card according to a second embodiment of the present invention will be described in more detail. FIG. 10 is a cross-sectional view illustrating a three-dimensional pattern card according to the second embodiment of the present invention. Referring to FIG. 10, the three-dimensional pattern card 9 according to the second embodiment of the present invention includes a three-dimensional pattern module 80 and a rear card body module 90.

The rear card body module 90 is a module made of a synthetic resin material and includes an antenna inlay 94, a first core sheet 92, a second core sheet 96, and a rear protective sheet 98. The antenna inlay 94 may be formed of a synthetic resin material, and an antenna coil may be mounted on one surface of the main body. The first core sheet 92 is formed of a synthetic resin material and may be disposed on an upper surface of the antenna inlay on which the antenna coil is mounted. The second core sheet 96 may be formed of a synthetic resin material and may be disposed on a lower surface of the antenna inlay. The rear protective sheet 98 may be formed of a synthetic resin material and may be disposed on a surface of the second core sheet.

The three-dimensional pattern module 80 is a module in which a three-dimensional pattern is formed on one surface, and may be configured by sequentially stacking a transparent sheet 82 and a three-dimensional pattern layer 86. The three-dimensional pattern module 80 may further include a printing layer 84 interposed between the transparent sheet 82 and the three-dimensional pattern layer 86. In addition, the three-dimensional pattern module 80 may further include a multilayer deposition film 88 formed on a surface of the three-dimensional pattern layer 86 in order to enhance a three-dimensional effect of the pattern of the three-dimensional pattern layer.

The transparent sheet 82 may be formed of a transparent synthetic resin material. The three-dimensional pattern layer 86 may be formed of a three-dimensional pattern shaped by curing a UV-curable material on a surface of the transparent sheet 82. The multilayer deposition film 88 may be formed by sequentially depositing predetermined materials on a surface of the three-dimensional pattern of the three-dimensional pattern layer, in order to enhance the three-dimensional effect of the pattern of the three-dimensional pattern layer. The types, deposition order, and deposition thickness of the materials constituting the multilayer deposition film 88 may be determined according to the color, transparency, and reflectivity required by the pattern of the three-dimensional pattern layer. The printing layer 84 may be disposed between the three-dimensional pattern layer and the transparent sheet, and may be formed by printing a predetermined design on a surface of the transparent sheet.

The three-dimensional pattern card according to the second embodiment of the present invention may further include a light-shielding layer 89 disposed between the three-dimensional pattern module 80 and the rear card body module 90 in order to block light from being transmitted through the rear card body module. The light-shielding layer 89 may be formed by applying a light-blocking material to one surface of the three-dimensional pattern module.

The three-dimensional pattern card according to the second embodiment of the present invention may further include an upper printing sheet 95 disposed on an upper surface of the three-dimensional pattern module 80. The upper printing sheet 95 may include a first transparent sheet 96, a design printing layer 97, and a second transparent sheet 98. The first transparent sheet 96 may be made of a transparent synthetic resin material. The design printing layer 97 may be formed by printing a predetermined pattern on a surface of the first transparent sheet 96. The second transparent sheet 98 may be formed on a surface of the design printing layer 97 and may be made of a transparent synthetic resin material.

The method for manufacturing a three-dimensional pattern card according to the second embodiment of the present invention includes first laminating a three-dimensional pattern module, in which a transparent sheet, a printing layer, a three-dimensional pattern layer, a multilayer deposition film, and a light-shielding layer are stacked, together with a rear card body module, in which a first core sheet, an antenna inlay, a second core sheet, and a rear protective sheet are stacked. Then, by thermally laminating the stacked result, the card can be completed.

While the present invention has been described with reference to certain exemplary embodiments, these embodiments are provided for purposes of illustration only and are not intended to be limiting. It will be apparent to those skilled in the art that various modifications, substitutions, alterations, and applications can be made without departing from the essential spirit and scope of the invention. All such modifications and equivalents are intended to be included within the scope of the present invention as defined by the appended claims.

What is claimed is:

1. A three-dimensional pattern card comprising: a three-dimensional pattern module having a three-dimensional pattern formed on one surface; a rear card body module made of a synthetic resin material; and a UV adhesive layer disposed between the three-dimensional pattern module and the rear card body module, the UV adhesive layer being formed by curing an adhesive of a UV-curable material to bond the three-dimensional pattern module and the rear card body module together, wherein the rear card body module comprises: an antenna inlay sheet having a body made of a synthetic resin material and an antenna coil mounted on one surface of the body; a first core sheet made of a synthetic resin material and disposed on an upper surface of the antenna inlay sheet on which the antenna coil is mounted; a second core sheet made of a synthetic resin material and disposed on a lower surface of the antenna inlay sheet; and a rear protective sheet made of a synthetic resin material and disposed on a surface of the second core sheet, and wherein the three-dimensional pattern module comprises: a transparent sheet made of a transparent synthetic resin material; and a three-dimensional pattern layer formed of a three-dimensional pattern shaped by curing a UV-curable material on a surface of the transparent sheet.

2. The three-dimensional pattern card according to claim 1, wherein the three-dimensional pattern module further comprises a multilayer deposition film formed by sequentially depositing predetermined materials on a surface of the three-dimensional pattern of the three-dimensional pattern layer to enhance a three-dimensional effect of the pattern, and wherein types, deposition order, and deposition thickness of the materials constituting the multilayer deposition film are determined according to color, transparency, and reflectivity required by the pattern of the three-dimensional pattern layer.

3. The three-dimensional pattern card according to claim 1, wherein the three-dimensional pattern module further comprises a printing layer disposed between the three-dimensional pattern layer and the transparent sheet, the printing layer being formed by printing a predetermined design on a surface of the transparent sheet.

4. The three-dimensional pattern card according to claim 1, wherein the rear card body module further comprises a light-shielding layer disposed on an upper surface of the first core sheet to block light transmission through the rear card body module, and
wherein the light-shielding layer is formed by applying a light-shielding material for blocking light onto the upper surface of the first core sheet.
